(19) United States
(12) Patent Application Publication
(10) Pub. No.: US 2019/0366276 A1
(43) Pub. Date: Dec. 5, 2019

(54) ZEOLITE MEMBRANE AND SEPARATION MEMBRANE

(71) Applicants: Sumitomo Electric Industries, Ltd., Osaka-shi (JP); Gifu University, Gifu-shi (JP)

(72) Inventors: Shinji ISHIKAWA, Yokohama-shi (JP); Hiromasa TAWARAYAMA, Yokohama-shi (JP); Takuya OKUNO, Yokohama-shi (JP); Takahiro SAITO, Yokohama-shi (JP); Yasunori OUMI, Gifu-shi (JP); Kyohei UENO, Gifu-shi (JP)

(73) Assignees: Sumitomo Electric Industries, Ltd., Osaka-shi (JP); Gifu University, Gifu-shi (JP)

(21) Appl. No.: 16/479,036

(22) PCT Filed: Jan. 16, 2018
(86) PCT No.: PCT/JP2018/000966

§ 371 Date: Jul. 18, 2019

(30) Foreign Application Priority Data
Jan. 18, 2017 (JP) 2017-006851

(51) Int. Cl. B01D 71/02; B01D 69/10; C01B 39/38

(52) U.S. Cl. CPC B01D 71/028; B01D 69/10; C01P 2004/03; C01P 2002/72; C01B 39/38

(57) ABSTRACT

There is provided a zeolite membrane which is an MFI-type zeolite membrane formed on an inorganic oxide porous substrate, in which, in a diffraction pattern obtained by X-ray diffraction measurement using a CuKα ray as an X-ray source, when an intensity of a diffraction peak appearing at diffraction angles of 7.3° to 8.4° at which a crystal lattice plane belongs to 011 and/or 101 planes is used as a reference, an intensity of a diffraction peak appearing at diffraction angles of 8.4° to 9.0° at which a crystal lattice plane belongs to 200 and/or 020 planes is preferably 0.3 or more.

### TECHNICAL FIELD

The present invention relates to a zeolite membrane and a separation membrane in which a zeolite membrane is formed on an inorganic oxide porous substrate.

This application is based upon and claims the benefit of priority from Japanese Patent Application No. 2017-6851, filed on Jan. 18, 2017, the entire content of which is incorporated herein by reference.

### BACKGROUND ART

Patent Literature 1 discloses a method of obtaining a separation membrane, in which a filmy material including a zeolite seed crystal, an organic structure directing agent, and silica is treated with water vapor to form an MFI-type zeolite membrane.

Patent Literature 2 discloses a zeolite membrane in which, in an XRD measurement, scattering intensity from 020 plane/scattering intensity from 101 plane is greater than 3.3, and scattering intensity from 020 plane/scattering intensity from 002 plane or 102 plane is greater than 4.4.

Patent Literature 3 discloses a zeolite membrane in which, in an XRD measurement, scattering intensity from 002 plane/scattering intensity from 020 plane is 2 or greater, scattering intensity from 002 plane/scattering intensity from 101 plane is 0.5 to 1.5, scattering intensity from 101 plane/scattering intensity from 501 plane is 1.5 or greater, and scattering intensity from 303 plane/scattering intensity from 501 plane is 2 or greater.

### CITATION LIST

### Patent Literature

Patent Literature 1; JP-A-2001-31416

Patent Literature 2: JP-A-2004-2160

Patent Literature 3: WO 2007/58388 A

### SUMMARY OF INVENTION

According to an aspect of the present invention, there is provided a zeolite membrane which is an MFI-type zeolite membrane formed on an inorganic oxide porous substrate, in which, in a diffraction pattern obtained by X-ray diffraction measurement using a CuKα ray as an X-ray source, when an intensity of a diffraction peak appearing at diffraction angles of 7.3° to 8.4° at which a crystal lattice plane belongs to 011 and/or 101 planes is used as a reference, an intensity of a diffraction peak appearing at diffraction angles of 8.4° to 9.0° at which a crystal lattice plane belongs to 200 and/or 020 planes is preferably 0.3 or more.

In addition, according to another aspect of the present invention, there is provided a separation membrane including the zeolite membrane according to the aspect of the present invention, on an inorganic oxide porous substrate formed of an amorphous body including 90% by mass or more of SiO₂.

### BRIEF DESCRIPTION OF DRAWINGS

FIG. 1 is a showing a view showing a configuration of a separation membrane according to an embodiment of the present invention.

FIG. 2 is a flowchart showing a production method according to an embodiment of the present invention.

FIG. 3A is a view showing XRD patterns of membranes synthesized using different water addition amounts in Example 1.

FIG. 3B is a view showing degree of crystallinity of the membranes synthesized using different water addition amounts in Example 1.

FIG. 4 is a view showing SEM images of the membranes synthesized using different water addition amounts in Example 1.

FIG. 5A is a view showing XRD patterns of membranes synthesized for different synthesis times in Example 2.

FIG. 5B is a view showing degree of crystallinity of the membranes synthesized for different synthesis times in Example 2.

FIG. 6 shows SEM images (part 1) of the membranes synthesized for different synthesis times in Example 2.

FIG. 7 shows SEM images (part 2) of the membranes synthesized for different synthesis times in Example 2.

FIG. 8 is a schematic view showing an example of an apparatus for evaluating permeability of the separation membrane.

FIG. 9 is a view showing a relationship between a flux and a separation factor α with respect to the synthesis time in Example 2.

FIG. 10 is a view showing XRD patterns of membranes synthesized at different TPAOH concentrations in Example 3.

FIG. 11 is an electron micrograph showing a structure of a surface of a separation membrane of Example 4-1.

FIG. 12 is an electron micrograph showing the structure of a cross-section of the separation membrane of Example 4-1, orthogonal to a longitudinal direction thereof.

FIG. 13 is an electron micrograph showing a structure of a surface of a separation membrane of Example 5-4.

FIG. 14 is an electron micrograph showing a structure of a cross-section of the separation membrane of Example 5-4, orthogonal to a longitudinal direction thereof.

FIG. 15 is an electron micrograph showing a structure of a cross-section of a separation membrane of Example 8-1, orthogonal to a longitudinal direction thereof.

FIG. 16 is a graph showing results of X-ray diffraction measurement of the surfaces of the separation membranes of Examples 4-1 and 5-4.

FIG. 17 is a graph showing results of X-ray diffraction measurement of the surface of the separation membrane of Example 8-1.

### DESCRIPTION OF EMBODIMENTS

### Problem to be Solved by Present Disclosure

In a hydrothermal synthesis method of the related art, a zeolite component is supplied from a solution side and a zeolite crystal grows from a surface with a seed crystal as a nucleus. Therefore, an oriented crystal membrane grows. In such a zeolite separation membrane having high orientation, since a separation factor becomes low due to a leak at a particle boundary, it is necessary to increase a membrane thickness in order to make the separation factor high. On the other hand, when the membrane thickness is increased, a permeation flux decreases. For this reason, a membrane structure in which both the permeation flux and a separation ratio are improved is required.

An object of the present invention is to provide a zeolite membrane and a separation membrane which are excellent in separability even with a thin thickness of the membranes, and have a large permeation flux.

### Advantageous Effects of Present Disclosure

According to the present invention, it is possible to provide a zeolite membrane and a separation membrane which are excellent in separability even with a thin thickness of the membranes, and have a large permeation flux.

### EMBODIMENTS OF PRESENT INVENTION

First, contents of an embodiment of the present invention will be listed and described.

A zeolite membrane according to an embodiment of the present invention is as follows.

(1) A zeolite membrane is an MFI-type zeolite membrane formed on an inorganic oxide porous substrate, in which, in a diffraction pattern obtained by X-ray diffraction measurement using a CuKα ray as an X-ray source, when an intensity of a diffraction peak appearing at diffraction angles of 7.3 to 8.4° at which a crystal lattice plane belongs to 011 and/or 101 planes is used as a reference, an intensity of a diffraction peak appearing at diffraction angles of 8.4 to 9.0° at which a crystal lattice plane belongs to 200 and/or 020 planes is preferably 0.3 or more.

According to this configuration, it is possible to provide a zeolite membrane which is excellent in permeation flux and separability even with a thin thickness of the membrane.

(2) The zeolite membrane according to (1), in which in the diffraction pattern, when the intensity of the diffraction peak appearing at diffraction angles of 7.3° to 8.4° at which the crystal lattice plane belongs to 011 and/or 101 planes is used as a reference, an intensity of a diffraction peak appearing at diffraction angles of 8.4° to 9.0° at which a crystal lattice plane belongs to 200 and/or 020 planes may be 0.4 or more.

(3) The zeolite membrane according to (1), in which in the diffraction pattern, when the intensity of the diffraction peak appearing at diffraction angles of 7.3° to 8.4° at which the crystal lattice plane belongs to 011 and/or 101 planes is used as a reference, an intensity of a diffraction peak appearing at diffraction angles of 22.7° to 23.5° at which a crystal lattice plane belongs to 501 and/or 051 planes may be 0.5 or more.

(4) The zeolite membrane according to (3), in which in the diffraction pattern, when the intensity of the diffraction peak appearing at diffraction angles of 7.3° to 8.4° at which the crystal lattice plane belongs to 011 and/or 101 planes is used as a reference, an intensity of a diffraction peak appearing at diffraction angles of 22.7° to 23.5° at which a crystal lattice plane belongs to 501 and/or 051 planes may be 0.6 or more.

(5) The zeolite membrane according to (1) or (3), in which in the diffraction pattern, when the intensity of the diffraction peak appearing at diffraction angles of 7.3° to 8.4° at which the crystal lattice plane belongs to 011 and/or 101 planes is used as a reference, an intensity of a diffraction peak appearing at diffraction angles of 12.9° to 13.5° at which a crystal lattice plane belongs to 002 plane may be 0.25 or less.

(6) The zeolite membrane according to any of (1), (3), and (5), in which in the diffraction pattern, when the intensity of the diffraction peak appearing at diffraction angles of 7.3° to 8.4° at which the crystal lattice plane belongs to 011 and/or 101 planes is used as a reference, an intensity of a diffraction peak appearing at diffraction angles of 26.8° to 27.2° at which a crystal lattice plane belongs to 104 plane may be 0.2 or less.

In addition, a zeolite membrane according to another embodiment of the present invention is as follows.

(7) A separation membrane includes the zeolite membrane according to any one of (1) to (6), on an inorganic oxide porous substrate formed of an amorphous body including 90% by mass or more of SiO₂.

According to this configuration, since the substrate is a high silica substrate, it is possible to suppress elution of alumina, to maintain hydrophobicity of the membrane, and to exhibit excellent separability. In addition, since the substrate itself is converted to zeolite, an affinity between the membrane and the substrate is favorable and excellent separability is exhibited.

(8) The separation membrane according to (7), in which the inorganic oxide porous substrate may be formed of an amorphous body including 99% by mass or more of SiO₂.

According to this configuration, since the substrate is a high silica substrate, it is possible to further suppress elution of alumina, to maintain hydrophobicity of the membrane, and to exhibit excellent separability. In addition, since the substrate itself is converted to zeolite, an affinity between the membrane and the substrate is more favorable and excellent separability is exhibited.

### DETAILS OF EMBODIMENTS OF PRESENT INVENTION

Hereinafter, embodiments of the present invention will be described in detail.

### 1. Separation Membrane

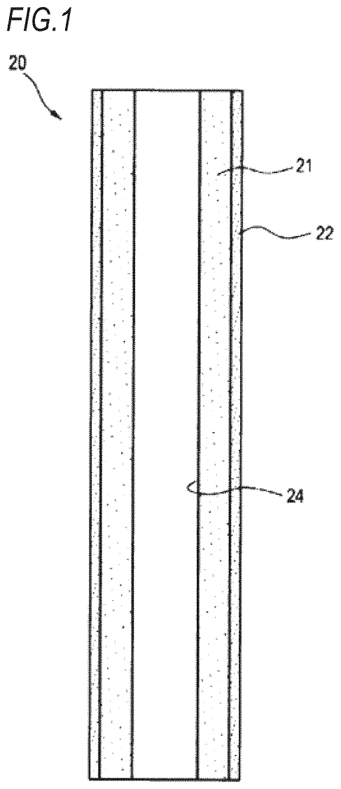

FIG. 1 shows an embodiment of a separation membrane. FIG. 1 is a longitudinal sectional view of the separation membrane.

A separation membrane 20 has a substantially cylindrical shape and has an inorganic oxide porous substrate 21 having a central hole 24. A zeolite membrane 22 is formed on an outer periphery of the porous substrate 21. A shape of the separation membrane can be any shape such as a planar shape, but in order to make a contact area with a fluid wider in terms of separation efficiency, a tubular shape is adopted in the present embodiment.

The separation membrane 20 can be used in a gas separation membrane that utilizes a molecular sieving effect or hydrophilic/hydrophobicity, a vaporation membrane, a membrane separation reactor, and the like. In particular, it can be suitably used as a separation membrane for ethanol/water separation.

### 1-1. Inorganic Oxide Porous Substrate

As the inorganic oxide porous substrate 21 used in the present embodiment, a main component of a portion (a surface portion of the substrate) in which the zeolite membrane 22 is formed according to the present embodiment may be amorphous SiO₂. For example, a substrate in which amorphous SiO₂ is formed on a surface of the substrate such as alumina, or a substrate in which a whole substrate is formed of amorphous SiO₂ can be used. In addition, the substrate 21 is preferably formed of an amorphous body including 90% by mass or more of SiO₂. The substrate 21 is further preferably an amorphous body including 99% by mass or more of SiO₂. The substrate 21 particularly preferably includes Al₂O₃ at less than 1% by mass.

When a content ratio of SiO₂ of the substrate increases and a content ratio of Al₂O₃ and impurities decreases, the elution of Al₂O₃, an alkali element, boron, and the like present in the substrate to the zeolite membrane 22 is suppressed and it is possible to maintain hydrophobicity of the separation membrane 20. In addition, since a slight amount of dissolved alumina makes it possible to improve alkali resistance of the silica substrate, during a treatment of forming a membrane of zeolite, it is possible to maintain a strength of the substrate by suppressing the elution from the substrate.

Since the porous substrate 21 supports the thin membrane without substantially interfering fluid permeation in the zeolite membrane 22, a porosity of the porous substrate 21 may be 35% to 70%, and an average pore size may be 250 nm to 600 nm. The “porosity” can be calculated as a proportion of a pore volume per unit volume.

Furthermore, a thickness of the porous substrate 21 is not particularly limited, and is preferably 0.2 mm to 5 mm, and more preferably 0.5 mm to 3 mm, in view of a balance between mechanical strength and gas permeability.

In addition, the specific surface area of the zeolite formation portion of the porous substrate 21 may be 5 m²/g or larger and 400 m²/g or smaller. When it is smaller than 5 m²/g, since a surface area is small, there is a concern that the amount of the structure directing agent that can be supported on a particle surface may be insufficient. In addition, an elution amount of the silica component by the alkaline component is insufficient, so there is a concern that complete conversion to zeolite may not be possible. On the other hand, when the specific surface area is larger than 400 m²/g, there is a concern that a supported amount of the structure directing agent may be excessive. In addition, the silica component may be excessively eluted more than necessary due to the permeation of the alkaline component into the substrate and a substrate strength may decreases, in some cases.

From the viewpoint of the former, it is desirable that an appropriate specific surface area is 10 m²/g or larger in which a size of the particle present in the surface of the porous substrate 21 is 0.5 μm or smaller. From the viewpoint of the latter, it is desirable that the appropriate specific surface area is 100 m²/g or smaller, in which the size of the particle is 50 nm or more.

### 1-2. Zeolite Membrane

The zeolite membrane 22 formed on the porous substrate 21 obtained according to the present embodiment is an MFI-type zeolite membrane and is a compact membrane compared to a zeolite membrane obtained by a hydrothermal synthesis method of the related art. Therefore, even when a membrane thickness of the zeolite membrane 22 of the present embodiment is thin, it is possible to provide a separation membrane, which is excellent in separability and has a large permeation flux.

In the zeolite membrane 22, in a diffraction pattern obtained by X-ray diffraction measurement using a CuKα ray as an X-ray source, when an intensity of a diffraction peak appearing at diffraction angles of 7.3° to 8.4° at which a crystal lattice plane belongs to 011 and/or 101 planes is used as a reference, an intensity of a diffraction peak appearing at diffraction angles of 8.4° to 9.0° at which a crystal lattice plane belongs to 200 and/or 020 planes is 0.3 or more and preferably 0.4 or more.

In addition, in the zeolite membrane 22, in the diffraction pattern obtained by X-ray diffraction measurement using a CuKα ray as an X-ray source, when the intensity of the diffraction peak appearing at diffraction angles of 7.3° to 8.4° at which the crystal lattice plane belongs to 011 and/or 101 planes is used as a reference, an intensity of a diffraction peak appearing at diffraction angles of 22.7° to 23.5° at which a crystal lattice plane belongs to 501 and/or 051 planes is preferably 0.5 or more and more preferably 0.6 or more.

In addition, in the zeolite membrane 22, in the diffraction pattern obtained by X-ray diffraction measurement using a CuKα ray as an X-ray source, when the intensity of the diffraction peak appearing at diffraction angles of 7.3° to 8.4° at which the crystal lattice plane belongs to 011 and/or 101 planes is used as a reference, an intensity of a diffraction peak appearing at diffraction angles of 12.9° to 13.5° at which a crystal lattice plane belongs to 002 plane is preferably 0.25 or less.

In addition, in the zeolite membrane 22, in the diffraction pattern obtained by X-ray diffraction measurement using a CuKα ray as an X-ray source, when the intensity of the diffraction peak appearing at diffraction angles of 7.3° to 8.4° at which the crystal lattice plane belongs to 011 and/or 101 planes is used as a reference, an intensity of a diffraction peak appearing at diffraction angles of 26.8° to 27.2° at which a crystal lattice plane belongs to 104 plane is preferably 0.2 or less.

For the X-ray diffraction measurement, for example, the measurement can be performed using a powder X-ray diffractometer D8 ADVANCE (manufactured by BRUKER Corporation), under an acceleration voltage of 40 KV, a current of 40 mA, a light source of CuKα, and a measurement angle of 5° to 80°.

A thickness of the zeolite membrane 22 is not particularly limited, and is preferably 0.5 μm to 30 μm. When the thickness is smaller than 0.5 μm, there are concerns that a pinhole is likely to be generated in the zeolite membrane 22 and sufficient separability cannot be obtained. In addition, when the thickness is more than 30 μm, a permeation rate of the fluid may too decrease, and it may be difficult to obtain practically sufficient permeation performance, in some cases.

### 2. Method of Producing Separation Membrane

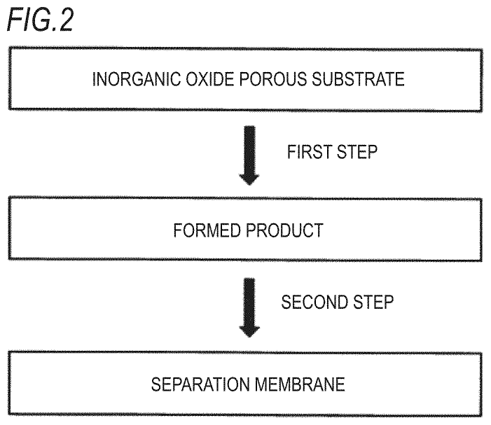

As shown in a flowchart in FIG. 2, the separation membrane 20 is produced by forming the zeolite membrane 22 on the surface of the substrate 21, by a first step of forming a zeolite seed crystal and an alkaline component including a structure directing agent, on the surface of the inorganic oxide porous substrate 21 by a method such as application to obtain a formed product, and a second step to treating the formed product obtained in the first step under the heated steam atmosphere.

### 2-1. First Step

In the first step, the zeolite seed crystal and the alkaline component including the structure directing agent are formed on the surface of the inorganic oxide porous substrate 21 by the method such as application. The zeolite seed crystal is a zeolite particle produced by a method of producing a standard zeolite particle. A particle size of the zeolite seed crystal is not particularly limited, and is, for example, 5 μm or smaller, and preferably 3 μm or smaller.

The structure directing agent is an agent of an organic compound forming a hole of zeolite, and for example, a quaternary ammonium salt such as tetraethyl ammonium hydroxide, tetrapropyl ammonium hydroxide, tetrapropyl ammonium bromide, and tetrabutyl ammonium hydroxide, and trimethyl adamantan ammonium salt are used.

The alkaline component represents an alkaline aqueous solution, and is preferably an aqueous solution including an organic ammonium hydroxide and/or an organic ammonium halogen salt and an alkali metal hydroxide. Examples of the organic ammonium hydroxide include tetrapropyl ammonium hydroxide (TPAOH). Examples of the organic ammonium halogen salt include tetrapropyl ammonium bromide (TPABr). Examples of the alkali metal hydroxide include sodium hydroxide or potassium hydroxide.

In a case of using the aqueous solution including the organic ammonium hydroxide as the alkaline component, since the zeolite membrane is formed of only the silica component and the organic ammonium, a separation membrane with very few impurity components can be formed and it is possible to suppress elution of impurities from the substrate or the membrane. In addition, in a case of using the aqueous solution including the organic ammonium halogen salt and the alkali metal hydroxide as the alkaline component, since the component is more stable than the organic ammonium hydroxide and the alkali concentration can be adjusted by a concentration of the alkali metal hydroxide, it is possible to construct a process in which substrate breakage or the like due to excess alkali is hard to occur.

In addition, the concentration of the structure directing agent in the alkaline component is preferably 0.05 M or more, in terms of proceeding of crystal growth. Furthermore, it is effective and preferable that the concentration of the structure directing agent in the alkaline component is 0.3 M or less, in terms of suppression of consumption of the substrate.

The formation of the zeolite seed crystal on the surface of the inorganic oxide porous substrate 21 can be performed, for example, by a method of immersing the inorganic oxide porous substrate 21 in an aqueous dispersion of the zeolite seed crystal and withdrawing. In this case, it is also possible to form the alkaline component to the surface of the inorganic porous substrate 21 by application simultaneously with the seed crystal, by adding the alkaline component to the aqueous dispersion of the zeolite seed crystal.

In addition, the formation of zeolite seed crystal can be performed also by preparing a zeolite-dispersed polymer membrane, winding the zeolite-dispersed membrane on a support outer surface, and baking off the polymer portion. In this case, dried zeolite powder is dispersed in a chloroform or an acetone solvent, and then polymethyl methacrylate is added and stirred. Thereafter, a polymer membrane in which the zeolite seed crystal is dispersed is prepared by a casting method. This membrane on the inorganic oxide porous substrate 21 is wound and bonded and then baked at 550° C. in air. Accordingly, a seed crystal layer can be formed on the surface of the inorganic oxide porous substrate 21.

In the present embodiment, the zeolite seed crystal may be formed on the inorganic oxide porous substrate 21 by electrophoresis. According to this method, a position and a density of the seed crystal can be controlled, and it is possible to further improve the compactness of the zeolite membrane 22 finally obtained. The electrophoresis is performed in a manner that, an inside of the porous substrate 21 whose upper and lower sides are sealed is filled with an organic solvent such as acetone, and an outside thereof is filled with an organic solvent in which the zeolite seed crystal is dispersed, and a voltage is applied to an electrode inside the porous substrate 21 and electrode on a container side, accordingly, the seed crystal is attached to the surface of the substrate 21. The electrophoresis is performed, for example, by applying 50 V of a voltage for 5 minutes. After attaching the seed crystal, the substrate 21 is pulled out of the solution and dried. Thereafter, formation of the seed crystal on the substrate 21 is completed, for example, by heat treatment at 300° C. for 6 hours.

After the seed crystal is attached by the electrophoresis, the upper and lower sides of the seed crystal-attached porous substrate are sealed, and dipped in TPAOH aqueous solution and then pulled up. Accordingly, an alkaline component can be formed on the surface by application. The TPAOH aqueous solution is preferably 0.05 M or more and 0.5 M or less, and for example, 0.1 M TPAOH aqueous solution can be used.

In addition, when the alkaline component on the substrate 21 is dried, the thickness and the concentration unevenness of the alkaline component on the substrate 21 can be suppressed, which is preferable.

### 3-2. Second Step

The formed product obtained in the first step is placed in a hydrothermal treatment container including 0.5% to 5% by volume of water per a container volume, and heat treatment is performed at 140° C. to 180° C. for a predetermined time, for example, 24 hours. Accordingly, the zeolite membrane can be formed on a periphery of the seed crystal.

In addition, the amount of water to be contained in the hydrothermal treatment container and used to set to the heated steam atmosphere is preferably twice or more the amount of saturated water vapor, because the water vapor supply to the membrane formation region is sufficiently performed. When the amount of water to be contained in the hydrothermal treatment container is more than 20 times the amount of saturated water vapor, there is a concern that a defect is likely to occur in a membrane structure. The amount of saturated water vapor (W_{H2O-S}) is water vapor mass at a saturated water vapor pressure (Ps) at a heat treatment temperature (T) at a unit volume (1 m³), and a unit thereof is g/m³. In a case of the mass in the container volume (V), it becomes W_{H2O-S}×V (g). The amount of saturated water vapor can be obtained by determining a saturated water vapor pressure (P(t)) at a predetermined temperature using an approximation, and converting it into the water vapor amount from a gas equation.

As approximation of the saturated water vapor pressure, there is a Wagner equation, which is as follows.

P(t)=Pc·exp[(Ax+Bx^{1.5}+Cx³+Dx⁶)/(1−x)] [Equation 1]

Here, Pc=221200 [hPa]: critical pressure, Tc=647.3 [K]: critical temperature, x=1−(t+273.15)/Tc, A=−7.76451, B=1.45838, C=−2.7758, D=−1.23303 (A to D: coefficients).

From the obtained saturated water vapor pressure P(t), the molar number of water vapor per unit volume is determined by the gas equation: P/RT=n/V, and the amount of saturated water vapor is obtained from the molecular weight of water.

In addition, it is preferable that the treatment under the heated steam atmosphere in the second step is performed for 4 hours or longer from the viewpoint of crystal growth. Furthermore, when it is 8 hours or longer, it is more preferable in that a zeolite crystal structure is stabilized. Here, when the treatment time is longer than 36 hours, crystallinity may deteriorate due to factors such as elution of the crystal component, and there is a concern that production time may increase.

The formed product obtained through the first and second steps is washed and then dried and baked at 350° C. to 600° C. for a predetermined time, for example, baked for 12 hours. Accordingly, the structure directing agent is burnt out to form the separation membrane 20.

According to the production method of the present embodiment, by using a small amount of the structure directing agent, it is advantageous compared to the hydrothermal synthesis method of the related art, from the viewpoint that it is possible to obtain a separation membrane having excellent separability and large permeation flux, and a viewpoint of costs.

### EXAMPLES

Hereinafter, results of the evaluation test using examples according to the present invention are shown, and the present invention will be described in more detail. The present invention is not limited to these Examples.

### (Porous Silica Substrate)

A porous silica tube with an outer diameter of 10 mm, an inner diameter of 8.4 mm, a length of 300 mm, a porosity of 64%, and an average pore size of 500 nm was created by an external CVD method and a tube obtained by cutting the porous silica tube into 30 mm of length was used as the porous silica substrate.

### (Seed Crystal Attached Porous Silica Substrate)

Using colloidal silica, TPABr, sodium hydroxide, and distilled water, as raw materials, and these were mixed such that a molar ratio of SiO₂:TPABr:NaOH:H₂O becomes 1:0.2:0.1:40, and were stirred at a room temperature for 60 minutes to obtain a sol for generating a seed crystal. This sol was reacted in a container made of polypropylene under stirring conditions for 144 hours at 100° C., to synthesize MFI-type zeolite crystal (Silicalite-1). The zeolite crystal was collected by suction filtration, washed with hot water, and subjected to drying for 10 hours at 60° C. to obtain a high silica zeolite seed crystal with a particle size of approximately 1 μm. As the colloidal silica, Cataloid SI-30 (registered trademark) (SiO₂ 30.17%, N₂O 0.4%, H₂O 69.43%) manufactured by Catalysts & Chemical Industries, Co. Ltd. was used.

0.5 g of high silica zeolite seed crystal was added to 100 mL of acetone solvent and ultrasonically dispersed for 30 minutes. An inside of the porous silica substrate whose upper and lower sides were sealed was filled with only an acetone solvent, and an outside thereof was filled with an acetone solvent in which the high silica zeolite seed crystal was dispersed, and 50 V of a voltage was applied to an electrode inside the substrate and an electrode on a container side for 5 minutes, accordingly, the seed crystal was attached to the surface of the substrate. This was pulled out of the solution, dried in air for 30 minutes, and heat treated at 300° C. for 6 hours to prepare a seed crystal attached porous silica substrate.

### Example 1 (Influence of Amount of Water)

Upper and lower sides of the seed crystal attached porous silica substrate were sealed, and the entire substrate was immersed in 0.1 M TPAOH aqueous solution and then pulled up. This was dried at 60° C. for 1 hour. Thereafter, the substrate was installed in a hydrothermal treatment container (in-container volume: 120 cc) containing water in a range of 1 g to 12 g, without touching the water, and heat treated at 160° C. for 24 hours to form a zeolite membrane on the surface of the substrate. After heat treatment, the formed product was washed, and dried at 60° C. for 10 hours, and then baked at 375° C. for 40 hours. Accordingly, the structure directing agent was removed to obtain separation membranes of Examples 1-1 to 1-5. The separation membranes in Examples 1-1 to 1-5 respectively represent separation membranes in which the amounts of water contained in the hydrothermal treatment container were 1 g, 3 g, 6 g, 9 g, and 12 g, respectively.

A structure of the surface of each of the obtained separation membranes was analyzed using a BRUKER powder X-ray diffraction (XRD) apparatus D8 ADVANCE. In addition, measurement was performed under conditions of an acceleration voltage of 40 KV, current of 40 mA, a light source of CuKα, and a measurement angle of 5° to 80°. In addition, the surface and a form of the cross section of the obtained separation membrane were observed by a scanning electron microscope (SEM).

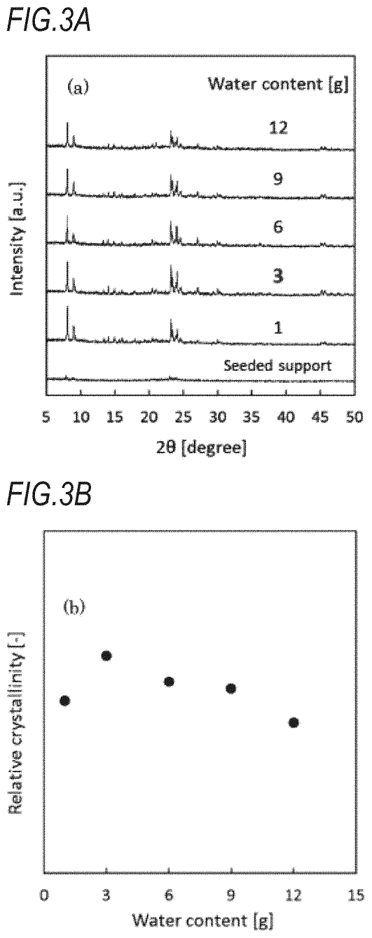

FIGS. 3A and 3B show XRD patterns in a case where the water addition amount was changed, and degrees of crystallinity obtained by the sum of intensities of top 15 peaks at 2θ=20-40°. In any of samples, it was confirmed that the MFI-based crystallinity increased after the hydrothermal treatment compared to before the treatment and no other impurity phase was formed. In addition, when the water addition amount was 3 g, it succeeded in the synthesis of a membrane having the highest crystallinity.

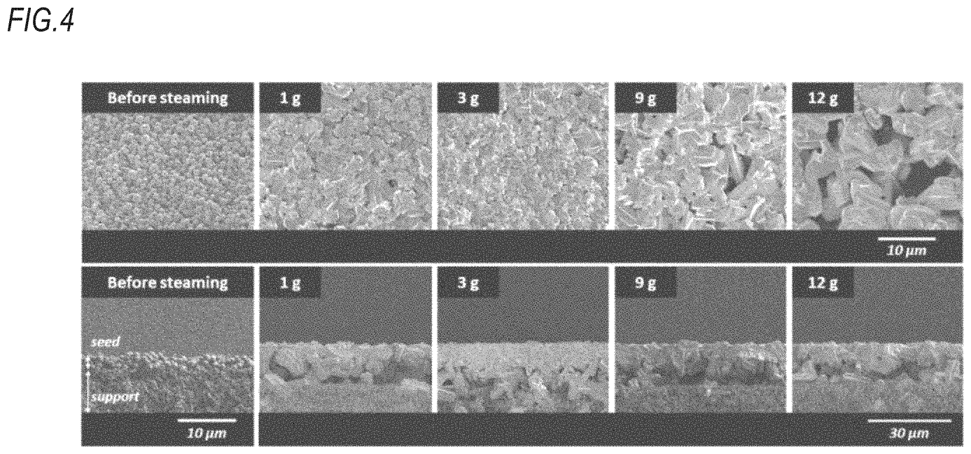

FIG. 4 shows photographs of the surface and the form of the cross section of the separation membrane observed by the SEM. The crystal form changed compared to that before the treatment, and when the water addition amount was 3 g, it succeeded in the synthesis of a continuous membrane with the highest compactness. Furthermore, it was confirmed that MFI-specific columnar crystal was formed between a compact zeolite layer and the support.

In a case where a hydrothermal container volume at 160° C. was 120 ml, the amount of saturated water vapor was 0.37 g. From the result, it can be seen that the water addition amount was preferably 3 g or more, which is much larger than the amount of saturated water vapor. In addition, it is assumed that, in a case of 3 g or more, since the crystal form significantly changes and voids between crystals are confirmed, the water amount is preferably 3 to 10 times the amount of the saturated water vapor. Of course, since this value may change depending on a container volume, a membrane formation substrate area, and the like, it is a value applicable to the present membrane forming conditions as a reference value.

### Example 2 (Influence of Heat Treatment Time)

In order to examine the influence of heat treatment time, a series of experiments shown below were conducted. Upper and lower sides of the seed crystal attached porous silica substrate were sealed, and the entire substrate was immersed in 0.1 M TPAHO aqueous solution and then pulled up. This was dried at 60° C. for 1 hour. Thereafter, the substrate was installed in a hydrothermal treatment container (in-container volume: 120 cc) containing 3 g of water, without touching the water, and heat treated at 160° C. for 2 to 48 hours to form a zeolite membrane on the surface of the substrate. After heat treatment, the formed product was washed, and dried at 60° C. for 10 hours, and then baked at 375° C. for 40 hours. Accordingly, the structure directing agent was removed to obtain separation membranes of Examples 2-1 to 2-8. The separation membranes of Examples 2-1 to 2-8 represent separation membranes in which the heat treatment times were 2 hours, 4 hours, 8 hours, 12 hours, 16 hours, 24 hours, 36 hours, and 48 hours, respectively. The structure of the surface of the obtained separation membrane was evaluated by XRD analysis and observation of the membrane structure by SEM, under the same conditions as those in Example 1.

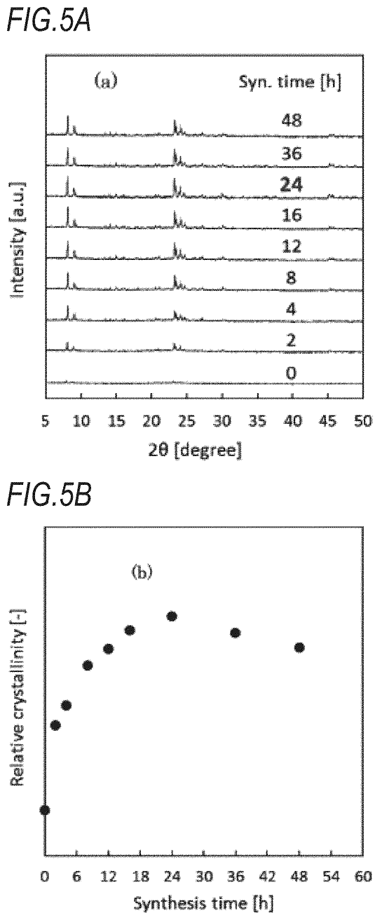

FIGS. 5A and 5B show XRD patterns (a) in a case where the heat treatment time was changed at 3 g of water addition amount, and degrees of crystallinity (b) obtained by the sum of intensities of top 15 peaks at 2θ=20-40°. Until the heat treatment time was up to 24 hours, as the heat treatment time increased, the degree of crystallinity improved. When the time was longer than 24 hours, the degree of crystallinity decreased. It is considered that, until 24 hours, the peak intensity increases due to the growth of the seed crystal and zeolitization of the support itself, but after 24 hours, the crystal growth stops and it is under an alkaline atmosphere, therefore the degree of crystallinity decreases due to remelting. From the result, it is considered that the optimal synthesis time is 24 hours, under the present conditions.

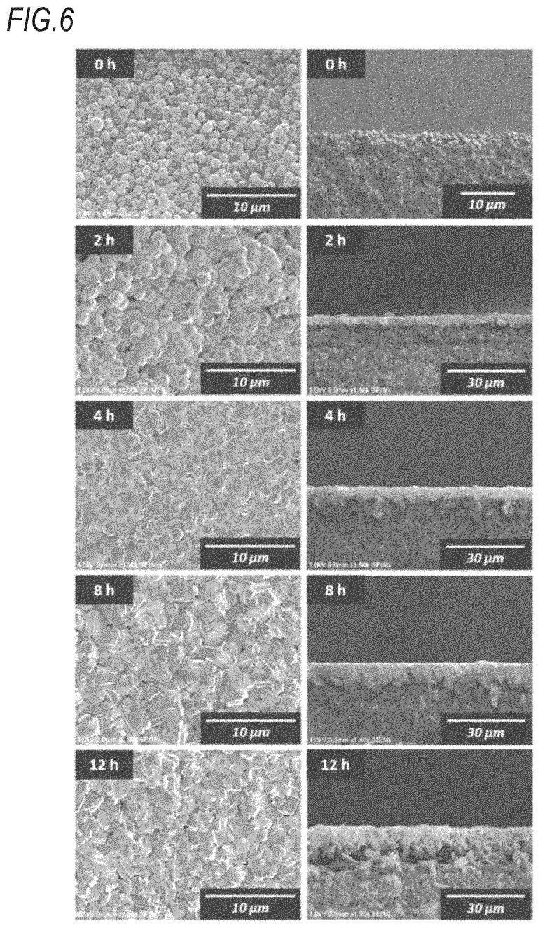

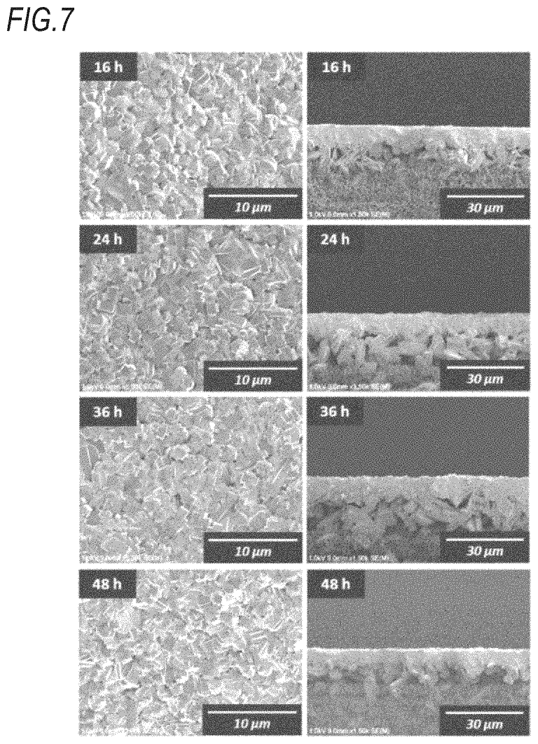

FIGS. 6 and 7 show photographs of the surface and the form of the cross section of the separation membrane observed by the SEM. The form of the separation membrane changed significantly with the increase in heat treatment time. From a cross-sectional SEM image, it was confirmed that until the heat treatment time was up to 8 hours, the substrate component was consumed for membrane formation and growth of the seed crystal layer and a compact zeolite layer was grown. It was confirmed that, when the heat treatment time exceeded 8 hours, Coffin type crystal derived from the support was formed between the compact zeolite layer and the support. A size of the Coffin type crystal increased as the heat treatment time increased from 12 hours to 24 hours. After 24 hours, there was no significant difference in the membrane form. The results of cross-sectional observation for up to 24 hours were consistent with tendency of crystallinity curves in FIG. 5B.

### (Pervaporation Test (PV: Pervaporation))

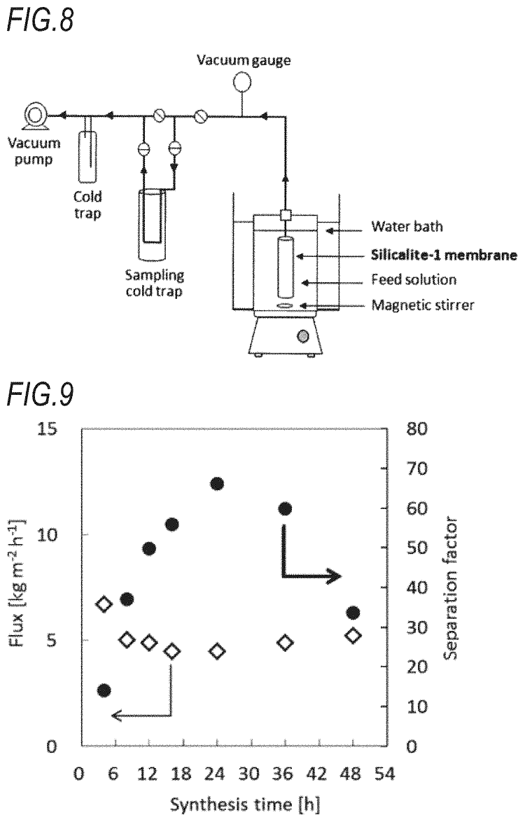

A performance of the separation membrane obtained in Example 2 was evaluated by a pervaporation test. The pervaporation test was conducted by an apparatus shown in a schematic view of FIG. 8. A 10% ethanol aqueous solution was heated in a water bath to 50° C. A separation membrane whose one-end was sealed and the other end was connected to a vacuum pump was placed therein, and an inside was depressurized, and a permeated liquid was collected at a predetermined time interval by a sampling cold trap. An obtained liquid composition on the depressurized side was measured by liquid chromatography to evaluate a state of separation concentration of the ethanol. Results of the pervaporation test are shown in Table 1 and FIG. 9.

TABLE 1
EtOH/H₂O pervaporation characteristic of separation
membrane prepared by changing heat treatment time

| Separation membrane | 2-1 | 2-2 | 2-3 | 2-4 | 2-5 | 2-6 | 2-7 | 2-8 |
|---|---|---|---|---|---|---|---|---|
| Heat treatment time (h) | 2 | 4 | 8 | 12 | 16 | 24 | 36 | 48 |
| Jₜₒₜₐₗ [kg/(m²h)] | 25.9 | 6.71 | 5.02 | 4.89 | 4.49 | 4.47 | 4.9 | 5.24 |
| EtOH Conc. [wt %] | 14 | 61 | 80 | 85 | 86 | 88 | 87 | 79 |
| α_{EtOH} | 1.4 | 14 | 37.1 | 49.9 | 55.8 | 66.1 | 59.9 | 33.7 |
| PSI | 11 | 87 | 181 | 239 | 249 | 291 | 288 | 171 |

In the table, Jₜₒₜₐₗ represents a permeation flux, EtOH Conc. represents the ethanol concentration of the permeated liquid, α_{EtOH} represents a separation factor, and PSI represents the pervaporation separation index. Jₜₒₜₐₗ, α_{EtOH}, and PSI are calculated by the following equations.

$${α}_{EtOH} = \frac{{( Ethanol \text{/} Water )}_{Permeation}}{{( Ethanol \text{/} Water )}_{Initiation}} , \\ {J}_{total} = \frac{Permeated weight [ kg ]}{Membrane area [ {m}^{2} ] \times Time [ h ]} , \\ PSI = J \times ( α - 1 ) \qquad [ Equation 2 ]$$

The separation factor α_{EtOH} changed with the heat treatment time, reached the maximum value at 24 hours, and then decreased. This tendency is also consistent with the graph (FIG. 5B) of the crystallinity curve calculated using the XRD pattern, and it became clear that the separation factor depends on the crystallinity of the membrane. In addition, it can be seen that the PSI value, which represents the performance of the membrane, reaches up to 290 at maximum.

### Example 3 (Influence of Concentration of Structure Directing Agent)

In order to examine the influence of the concentration of the structure directing agent, a series of experiments shown below were conducted. Upper and lower sides of the seed crystal attached porous silica substrate were sealed, and the entire substrate was immersed in 0.01 to 0.5 M TPAOH aqueous solution and then pulled up. This was dried at 60° C. for 1 hour. Thereafter, the substrate was installed in a hydrothermal treatment container (in-container volume: 120 cc) containing 3 g of water, without touching the water, and heat treated at 160° C. for 24 hours to form a zeolite membrane on the surface of the substrate. After heat treatment, the formed product was washed, and dried at 60° C. for 10 hours, and then baked at 375° C. for 40 hours. Accordingly, the structure directing agent was removed to obtain separation membranes of Examples 3-1 to 3-7. The separation membranes of Examples 3-1 to 3-7 represent separation membranes in which TPAOH concentrations in the TPAOH aqueous solution were 0.01 M, 0.05 M, 0.075 M, 0.1 M, 0.125 M, 0.3 M, and 0.5 M, respectively. The structure of the surface of the obtained separation membrane was evaluated by XRD analysis under the same conditions as those in Example 1.

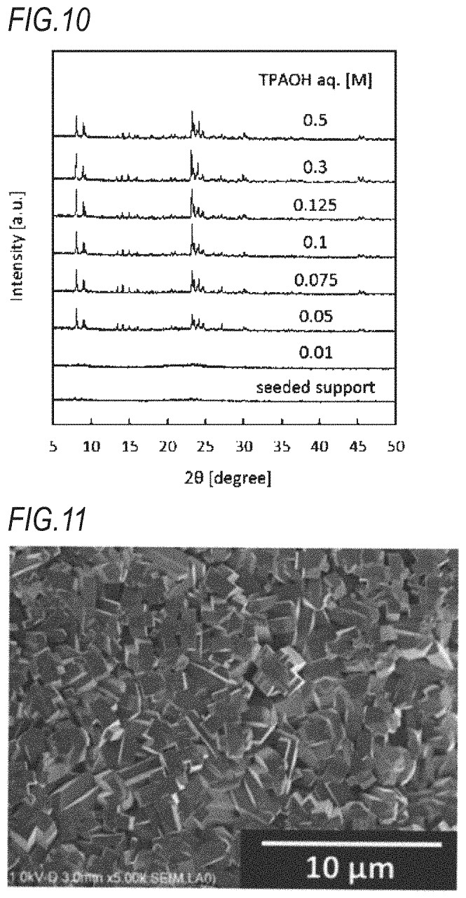

FIG. 10 shows XRD patterns in a case where the concentration of the structure directing agent (TPAOH) was changed by fixing the water addition amount as 3 g and the synthesis time as 24 hours. When the TPAOH concentration is 0.01 M, it can be confirmed, from the XRD pattern, that the seed crystal is hardly grown after the treatment. The degree of the crystallinity of the membrane increases to a concentration of 0.1 M and then gradually decreases. Therefore, it was found that there was a suitable TPAOH concentration. Furthermore, regarding the separation membranes in which a TPAOH concentration was 0.3 M and 0.5 M, a mechanical strength of the membrane was weaker and damage to the support was greater, compared to those of the separation membrane in which a TPAOH concentration was 0.1 M. From the result, it was confirmed that it is preferable that the structure directing agent (TPAOH) concentration was 0.1 M under the present conditions.

### Example 4 (Effect of Changing Membrane Thickness by Changing Seed Crystal Adhesion Amount)

Separation membranes of Examples 4-1 to 4-3 were produced in the same manner as in Example 2-6, except that the membrane thickness of the zeolite membrane was adjusted by changing the seed crystal adhesion amount. Then, the pervaporation test was carried out in the same manner as the evaluation in the separation membrane obtained in Example 2. Results thereof are shown in Table 2.

TABLE 2
EtOH/H₂O pervaporation test results of separation membranes
each having different zeolite membrane thickness

| Separation membrane | 4-1 | 4-2 | 4-3 |
|---|---|---|---|
| Membrane thickness (μm) | 6 | 8 | 9 |
| Jₜₒₜₐₗ [kg/(m²h)] | 4.88 | 5.02 | 5.19 |
| EtOH Conc. [wt %] | 75.7 | 76.9 | 75.6 |
| α_{EtOH} | 28.1 | 30 | 28 |
| PSI | 137 | 151 | 145 |

### (Method of Related Art)

Examples 5 to 8 shown below are examples related to a hydrothermal synthesis method of the related art, which will be used as comparative examples with respect to the present invention. Examples 5 to 7 are examples in which zeolite membrane was formed on a silica substrate by hydrothermal synthesis method, and Example 8 is an example in which the zeolite membrane was formed on an alumina substrate by hydrothermal synthesis method.

### <Example 5 (Study on Hydrothermal Synthesis Method 1: Influence of Hydrothermal Synthesis Time)

Using colloidal silica, TPABr, sodium hydroxide, and distilled water, as raw materials, and these were mixed such that a molar ratio of SiO₂:TPABr:NaOH:H₂O becomes 1:0.05:0.05:75, and were stirred at 22° C. for 60 minutes to obtain a sol for forming a membrane. The above-described seed crystal attached porous silica substrate was immersed in the sol for forming a membrane, and treated at 160° C. in a hydrothermal treatment container (in-container volume: 120 cc) for 4 to 24 hours to synthesize zeolite with the seed crystal on the substrate as a core. After the heat treatment, the formed product was washed, and dried at 60° C. for 10 hours, and then baked at 375° C. for 60 hours. Accordingly, the structure directing agent was removed to obtain separation membranes of Examples 5-1 to 5-4. The separation membranes of Examples 5-1 to 5-4 represent separation membranes in which the heat treatment times were 4 hours, 8 hours, 6 hours, and 24 hours, respectively.

Then, the pervaporation test was carried out in the same manner as the evaluation in the separation membrane obtained in Example 2. Results thereof are shown in Table 3.

TABLE 3
EtOH/H₂O pervaporation test results of separation
membranes obtained in Example 5

| Separation membrane | 5-1 | 5-2 | 5-3 | 5-4 |
|---|---|---|---|---|
| Heat treatment time (h) | 4 | 8 | 16 | 24 |
| Jₜₒₜₐₗ [kg/(m²h)] | 3.71 | 3 | 2.51 | 2.16 |
| EtOH Conc. [wt %] | 86.4 | 91.1 | 91.3 | 91.6 |
| α_{EtOH} | 57 | 92 | 95 | 98 |
| PSI | 208 | 273 | 236 | 210 |

From the result of Example 5, it was found that it is possible to obtain a higher separation factor α by an appropriate hydrothermal treatment time even in the hydrothermal synthesis method, but the permeation flux Jₜₒₜₐₗ remains in the order of 3 [kg/(m²h)].

### <Example 6 (Study on Hydrothermal Synthesis Method 2: Effect of Molar Ratio of TPABr to SiO₂)

Using colloidal silica, TPABr, sodium hydroxide, and distilled water, as raw materials, and these were mixed such that a molar ratio of SiO₂:TPABr:NaOH:H₂O becomes 1:0.005 to 0.1:0.05:75, and were stirred at 22° C. for 60 minutes to obtain a sol for forming a membrane. The above-described seed crystal attached porous silica substrate was immersed in the sol for forming a membrane, and treated at 160° C. in a hydrothermal treatment container (in-container volume: 120 cc) for 12 hours to synthesize zeolite with the seed crystal on the substrate as a core. After the heat treatment, the formed product was washed, and dried at 60° C. for 10 hours, and then baked at 375° C. for 60 hours. Accordingly, the structure directing agent was removed to obtain separation membranes of Examples 6-1 to 6-4. The separation membranes of Examples 6-1 to 6-4 represent separation membranes in which the molar ratios of TPABr to SiO₂ were 0.005, 0.001, 0.05, and 0.1, respectively.

Then, the pervaporation test was carried out in the same manner as the evaluation in the separation membrane obtained in Example 2. Results thereof are shown in Table 4.

TABLE 4
EtOH/H₂O pervaporation test results of separation
membranes obtained in Example 6

| Separation membrane | 6-1 | 6-2 | 6-3 | 6-4 |
|---|---|---|---|---|
| Molar ratio of TPABr to SiO₂ | 0.005 | 0.01 | 0.05 | 0.1 |
| Jₜₒₜₐₗ [kg/(m²h)] | 3.90 | 2.93 | 2.79 | 2.64 |
| EtOH Conc. [wt %] | 83.6 | 88.3 | 89.2 | 89.6 |
| α_{EtOH} | 45.8 | 67.9 | 74.1 | 77.4 |
| PSI | 174.4 | 195.9 | 204.2 | 201.5 |

### Example 7 (Study on Hydrothermal Synthesis Method 3: Influence of Gel Aging Temperature)

In the hydrothermal synthesis method, a property of the obtained membrane is likely to change depending on a state of a starting gel. Here, membrane formation results in an aged state without fixing a gel aging temperature to 22° C. in an uncontrolled at room temperature were evaluated.

Using colloidal silica, TPABr, sodium hydroxide, and distilled water, as raw materials, and these were mixed such that a molar ratio of SiO₂:TPABr:NaOH:H₂O becomes 1:0.005 to 0.1:0.05:75, and were stirred by setting to a room temperature (22° C. to 25° C.) for 60 minutes to obtain a sol for forming a membrane. The above-described seed crystal attached porous silica substrate was immersed in the sol for forming a membrane, and treated at 160° C. in a hydrothermal treatment container (in-container volume: 120 cc) for 12 hours to synthesize zeolite with the seed crystal on the substrate as a core. After the heat treatment, the formed product was washed, and dried at 60° C. for 10 hours, and then baked at 375° C. for 60 hours. Accordingly, the structure directing agent was removed to obtain separation membranes of Examples 7-1 to 7-4. The separation membranes of Examples 7-1 to 7-4 represent separation membranes in which the molar ratios of TPABr to SiO₂ were 0.005, 0.001, 0.05, and 0.1, respectively.

Then, the pervaporation test was carried out in the same manner as the evaluation in the separation membrane obtained in Example 2. Results thereof are shown in Table 5.

TABLE 5
EtOH/H₂O pervaporation test results of separation
membranes obtained in Example 7

| Separation membrane | 7-1 | 7-2 | 7-3 | 7-4 |
|---|---|---|---|---|
| Molar ratio of TPABr to SiO₂ | 0.005 | 0.01 | 0.05 | 0.1 |
| Jₜₒₜₐₗ [kg/(m²h)] | 4.35 | 2.56 | 2.3 | 2.66 |
| EtOH Conc. [wt %] | 66 | 85 | 89 | 84 |
| α_{EtOH} | 17.5 | 50.9 | 70.4 | 46.5 |
| PSI | 72 | 128 | 160 | 123 |

From the results of Examples 6 and 7, it can be seen that the hydrothermal synthesis method is sensitive to the production conditions of the starting gel of a membrane to be obtained and it is necessary to precisely control the aging temperature of the gel.

### Example 8 (Influence of Substrate in Hydrothermal Synthesis: Alumina Substrate)

High silica zeolite seed crystals were attached by electrophoresis on a porous alumina tube manufactured by Nikkato, of which an outer diameter was 12 mm, an inner diameter was 9 mm, a length was 80 mm, a porosity was 38%, and an average pore size was 1400 nm, to prepare a seed crystal attached porous alumina substrate.

Using colloidal silica, TPABr, sodium hydroxide, and distilled water, as raw materials, and these were mixed such that a molar ratio of SiO₂:TPABr:NaOH:H₂O becomes 1:0.005:0.05:50 to 150, and were stirred at a room temperature for 60 minutes to obtain a sol for forming a membrane.

The substrate was immersed in the sol for forming a membrane described above, and treated in the hydrothermal treatment container (in-container volume: 120 cc) at 160° C. for 24 hours. Zeolite was synthesized with the seed crystal on the substrate as a core. After the heat treatment, the formed product was washed, and dried at 60° C. for 10 hours, and then baked at 375° C. for 60 hours. Accordingly, the structure directing agent was removed to obtain separation membranes of Examples 8-1 to 8-5. The separation membranes of Examples 8-1 to 8-5 represent separation membranes in which the molar ratios of H₂O to SiO₂ were 150, 125, 100, 75, and 50, respectively.

Then, the pervaporation test was carried out in the same manner as the evaluation in the separation membrane obtained in Example 2. Results thereof are shown in Table 6.

TABLE 6
EtOH/H₂O pervaporation test results of separation
membranes obtained in Example 8

| Separation membrane | 8-1 | 8-2 | 8-3 | 8-4 | 8-5 |
|---|---|---|---|---|---|
| SiO₂/H₂O | 1/150 | 1/125 | 1/100 | 1/75 | 1/50 |
| Membrane thickness [μm] | 4 | 6 | 8 | 9 | 12 |
| Jₜₒₜₐₗ [kg/(m²h)] | 0.69 | 0.38 | 0.82 | 0.47 | 0.71 |
| EtOH Conc. [wt %] | 52.0 | 58.0 | 84.0 | 91.0 | 86.0 |
| α_{EtOH} | 10.8 | 13.6 | 42.5 | 88.0 | 66.0 |
| PSI | 7 | 5 | 34 | 40 | 46 |

From the result of Example 8, in a case where the alumina substrate was used, it was possible to confirm that both the permeation flux and α_{EtOH} were lower than those in the hydrothermal synthesis method using the silica substrate or a gel free method according to Examples 1 to 4 using the silica substrate. That is, it was confirmed that separation property was improved by using the silica substrate.

### (Influence of Synthesis Method and Substrate on Surface Structure of Separation Membrane)

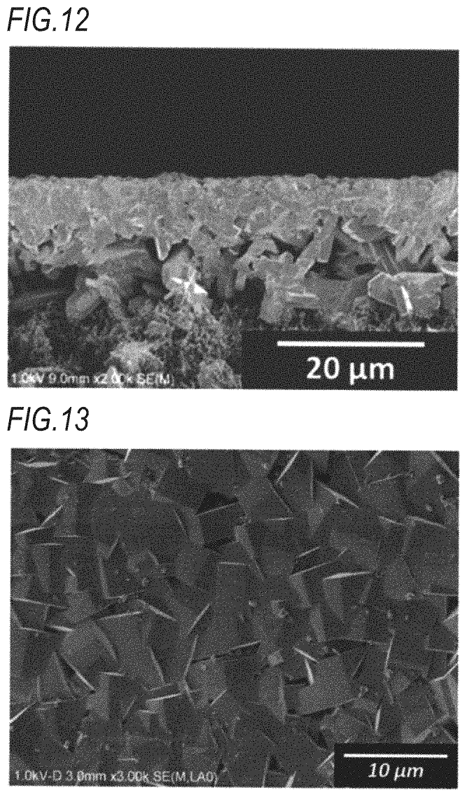

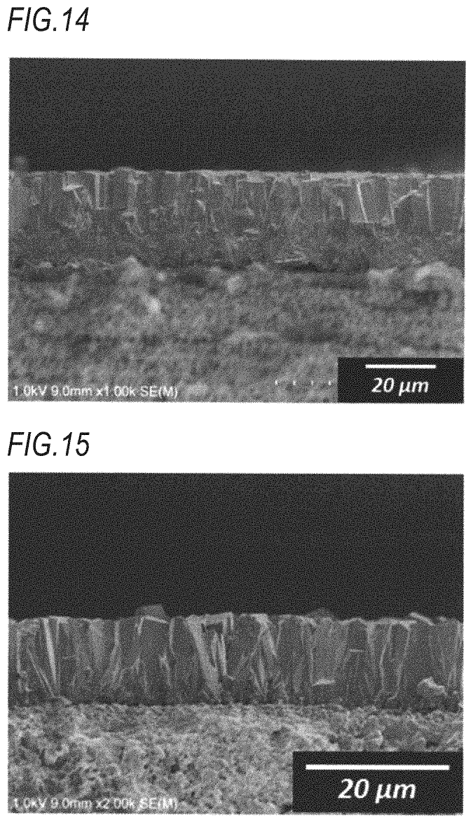

FIGS. 11 and 12 respectively show observation photographs of the surface of the separation membrane of Example 4-1 and the cross section thereof orthogonal to a longitudinal direction, obtained by the electron microscope. In addition, observation photographs of the surface of the separation membrane of Example 5-4 and the cross section thereof orthogonal to a longitudinal direction, obtained by the electron microscope are shown in FIGS. 13 and 14, respectively. It was confirmed that the separation membrane of Example 4-1 had a zeolite membrane formed of finer crystals and had compactness, compared to the separation membrane of Example 5-4.

Furthermore, FIG. 15 shows an observation photograph of a cross-section of the separation membrane of Example 8-1, orthogonal to a longitudinal direction thereof, obtained by the electron micrograph. In a case where the support was an alumina substrate, formation of a compact membrane was not confirmed.

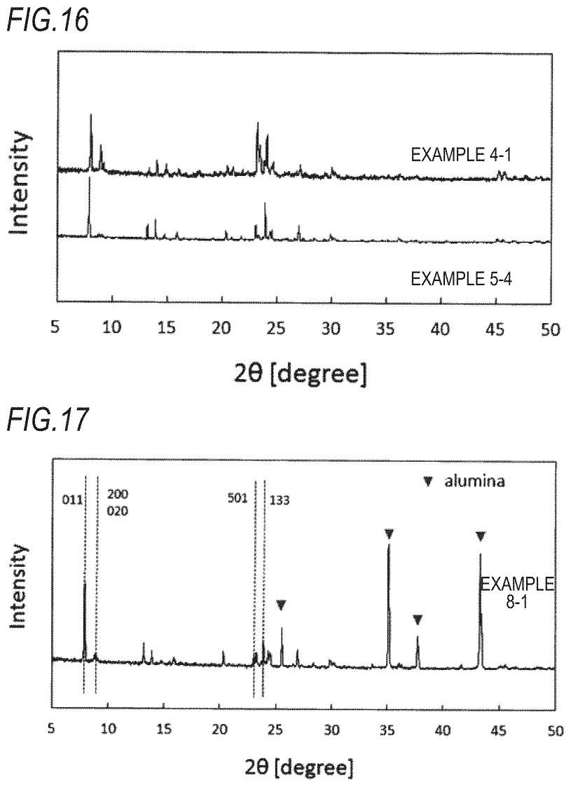

Also, a structure of the surface of each of the obtained separation membranes of Examples 4-1, 5-4, and 8-1 was analyzed using a powder X-ray diffraction apparatus D8 ADVANCE (manufactured by BRUKER Corporation). In addition, measurement was performed under conditions of an acceleration voltage of 40 KV, current of 40 mA, a light source of CuKα, and a measurement angle of 5° to 80°. Spectra obtained are shown in FIGS. 16 and 17. Using intensity of the diffraction peak appearing at diffraction angles of 7.3 to 8.4° at which the crystal lattice plane belongs to 011 and/or 101 planes as a standard, results of normalization of peak intensities were shown in Table 7.

TABLE 7

| | | | Example 5-4 | Example 8-1 |
|---|---|---|---|---|
| | | | (Silica/ | (Alumina/ |
| | Diffraction | Example 4-1 | Hydro- | Hydro- |
| | angle range | (Silica/ | thermal | thermal |
| Crystal plane | (°) | Steaming) | method) | method) |
| (011&101) | 7.3 to 8.4 | 1 | 1 | 1 |
| (200&020) | 8.48 to 9 | 0.34 | 0.07 | 0.11 |
| (002) | 13 to 13.4 | 0.18 | 0.25 | 0.26 |
| (102) | 13.6 to 14.2 | 0.25 | 0.33 | 0.18 |
| (501&051) | 22.8 to 23.5 | 0.61 | 0.26 | 0.18 |
| (133, 303) | 23.7 to 24.2 | 0.38 | 0.6 | 0.26 |
| (104) | 26.8 to 27.2 | 0.15 | 0.27 | 0.24 |

From Table 7, compared to the zeolite membrane obtained by the hydrothermal synthesis method using the alumina substrate or the silica substrate, in the zeolite membrane formed by the production method according to the embodiment of the present application, it was confirmed that peak intensities normalized using the intensity of the diffraction peak appearing at diffraction angles of 7.3° to 8.4° at which the crystal lattice plane belongs to 011 and/or 101 planes as a standard were greatly different.

Although the present invention has been described in detail with reference to specific aspects, it will be apparent to those skilled in the art that various changes and modifications can be made therein without departing from the spirit and scope of the present invention.

### REFERENCE SIGNS LIST

20: Separation membrane
21: Inorganic oxide porous substrate
22: Zeolite membrane
24: Central hole

1. A zeolite membrane which is an MFI-type zeolite membrane formed on an inorganic oxide porous substrate, wherein
in a diffraction pattern obtained by X-ray diffraction measurement using a CuKα ray as an X-ray source, when an intensity of a diffraction peak appearing at diffraction angles of 7.3° to 8.4° at which a crystal lattice plane belongs to 011 and/or 101 planes is used as a reference, an intensity of a diffraction peak appearing at diffraction angles of 8.4° to 9.0° at which a crystal lattice plane belongs to 200 and/or 020 planes is preferably 0.3 or more.

2. The zeolite membrane according to claim 1, wherein
in the diffraction pattern, when the intensity of the diffraction peak appearing at diffraction angles of 7.3° to 8.4° at which the crystal lattice plane belongs to 011 and/or 101 planes is used as a reference, an intensity of a diffraction peak appearing at diffraction angles of 8.4° to 9.0° at which a crystal lattice plane belongs to 200 and/or 020 planes is 0.4 or more.

3. The zeolite membrane according to claim 1, wherein
in the diffraction pattern, when the intensity of the diffraction peak appearing at diffraction angles of 7.3° to 8.4° at which the crystal lattice plane belongs to 011 and/or 101 planes is used as a reference, an intensity of a diffraction peak appearing at diffraction angles of 22.7° to 23.5° at which a crystal lattice plane belongs to 501 and/or 051 planes is 0.5 or more.

4. The zeolite membrane according to claim 3, wherein
in the diffraction pattern, when the intensity of the diffraction peak appearing at diffraction angles of 7.3° to 8.4° at which the crystal lattice plane belongs to 011 and/or 101 planes is used as a reference, an intensity of a diffraction peak appearing at diffraction angles of 22.7° to 23.5° at which a crystal lattice plane belongs to 501 and/or 051 planes is 0.6 or more.

5. The zeolite membrane according to claim 1, wherein
in the diffraction pattern, when the intensity of the diffraction peak appearing at diffraction angles of 7.3° to 8.4° at which the crystal lattice plane belongs to 011 and/or 101 planes is used as a reference, an intensity of a diffraction peak appearing at diffraction angles of 12.9° to 13.5° at which a crystal lattice plane belongs to 002 plane is 0.25 or less.

6. The zeolite membrane according to claim 1, wherein
in the diffraction pattern, when the intensity of the diffraction peak appearing at diffraction angles of 7.3° to 8.4° at which the crystal lattice plane belongs to 011 and/or 101 planes is used as a reference, an intensity of a diffraction peak appearing at diffraction angles of 26.8° to 27.2° at which a crystal lattice plane belongs to 104 plane is 0.2 or less.

7. A separation membrane comprising:
the zeolite membrane according to claim 1, on an inorganic oxide porous substrate formed of an amorphous body including 90% by mass or more of SiO₂.

8. The separation membrane according to claim 7, wherein
the inorganic oxide porous substrate is formed of an amorphous body including 99% by mass or more of SiO₂.
